(19) United States
(12) Patent Application Publication
(10) Pub. No.: US 2026/0176891 A1
(43) Pub. Date: Jun. 25, 2026

(54) SAFE LOCK

(71) Applicant: KNOCK N'LOCK LTD., Yokneam (IL)

(72) Inventor: Ilan GOLDMAN, Herzliya (IL)

(73) Assignee: KNOCK N'LOCK LTD., Yokneam (IL)

(21) Appl. No.: 19/543,829

(22) Filed: Feb. 18, 2026

Related U.S. Application Data
(63) Continuation-in-part of application No. PCT/IL2024/051006, filed on Oct. 14, 2024.

(30) Foreign Application Priority Data
Oct. 19, 2023 (IL) 307890

(51) Int. Cl. E05B 47/00; E05B 65/00

(52) U.S. Cl. CPC E05B 47/0012; E05B 65/0075; E05B 2047/0016; E05B 2047/0024; E05B 2047/0036

(57) ABSTRACT

Provided by this disclosure is a safe lock that can be fitted onto, or may be an integral part of, a safe door. The lock comprises a bolt switchable between a bolt open position and a bolt locking position, and a bolt blocking mechanism that comprises a rotatable blocking cam, a displaceable floating block and an electric motor.

### TECHNOLOGICAL FIELD

This disclosure concerns a safe lock, particularly locks that may be used for retrofitting a safe.

### GENERAL DESCRIPTION

Provided by this disclosure is a safe lock that can be fitted onto, or may be an integral part of, a safe door. The safe locks of this disclosure may also be used for retrofitting safes.

The safe lock comprises a housing that houses a bolt and a bolt blocking mechanism. The bolt is switchable, in a bolt path that extends in a locking plane, between a bolt locking position that locks the safe when installed in a safe door and the door is closed, and a bolt open position in which the safe can be opened.

By one embodiment, the bolt is a sliding bolt that is displaced in a linear bolt path between the bolt locking and bolt open positions. By another embodiment, the bolt is a rotary bolt that is displaced in a rotary bolt path between the bolt locking and bolt open positions. As will become clear from the description below, the disclosure herein is not limited by the nature of the bolt's displacement direction and/or the bolt path.

As will be further noted below, the lock has a blocking cam that has a blocking state, in which the blocking cam blocks the bolt in the bolt locking position; the bolt's switch to the bolt open position is enabled when the blocking cam is rotated into a non-blocking state. The switch of the bolt to the bolt open position (when this is enabled) and back to the closing position may be achieved, for example, by a manual mechanism of operating the bolt, e.g. through operating a handle or by an electrical switching mechanism. This disclosure is not limited by the manner in which such switching is achieved.

The bolt blocking mechanism comprises a blocking cam, a floating block and an electric motor, that may be a gear motor. The electric motor is rotatable in an opening rotation between a closed state and an open state, and rotatable in a closing rotation between the open state and the closed state.

The floating block is reciprocally displaceable between a first block position and a second block position and is biased, by a biasing element, into the first block position. The biasing element is typically, but not exclusively, a helical spring that is housed within a track; the track also houses the floating block which is displaceable within the track between the two block positions.

The blocking cam is rotatable in a cam plane normal to said locking plane, between a blocking state, in which it blocks the bolt from switching into the opening position, and a non-blocking state in which such switching is permitted.

The blocking cam, the floating block and the electric motor are coupled to one another, such that the opening rotation of the electric motor causes rotation of the blocking cam from the blocking state to the unblocking state and a displacement of the floating block from the first block position into the second block position. Through its coupling with the floating block assembly, the bias of the biasing element on the floating block concomitantly biases the rotation of the blocking cam back into said blocking state.

By one embodiment, the blocking cam has an extending portion, e.g. a generally radially extending arm, that in the blocking state is situated within the bolt path to thereby block the switch of the bolt into the bolt open position.

By one embodiment the blocking cam is physically coupled to the floating block. For example, the floating block may have a depression, the blocking cam may have a projection that fits into the depression the coupling being through such fitting, and the coupling may thereby permit concomitant rotation of the blocking cam and linear reciprocation of the blocking cam.

The motor is configured to be switched off after completing the opening rotation.

As noted above, the electric motor may be a gear motor in which the revolution rate of the electric motor is reduced through a gear system to lower revolution rate (lower RPM). Examples are gear motors with a gear ration of about 1:50 to about 1:400, e.g. about 1:75 to about 1:300, and typically about 1:100 to about 1:250. While the gear motor can induce a torque that can displace the floating block, the gear motor functions to resist rotation resulting from an incidental impact that may cause undesired displacement of the floating block; the gear motor is utilized such that torque on the motor axel applied by such impact would be insufficient to cause rotation of the motor. The bias on the floating block, that is coupled to the blocking cam, as noted above, can cause the blocking cam to transition into locking-ready intermediate state, in which the blocking cam rests against the bolt. This occurs after switching the bolt into its unlocked position. Consequently, when the bolt is subsequently switched from the bolt open position into the bolt locked position, the bias of the biasing element induces the motor cam to transition into its first rotational state to thereby rotate the blocking cam into the blocking state.

Typically, in order to enable the blocking cam's rotation, the rotational force exerted by the motor exceeds that of the biasing force of the biasing element. However, it should be noted that other arrangements may also be possible, for example blocking the biasing element during rotation of the blocking cam so as to block the biasing element's ability to exert biasing force onto the floating block during such rotation.

Typically, the bolt locking mechanism comprises a motor cam that is fixedly coupled to the motor's axle, and hence rotatable thereby, and is also coupled to the blocking cam and to the floating block.

By one embodiment the motor cam and the blocking cam are co-planar. In other embodiments of this disclosure, the blocking cam may rotate in a different plane than that of the motor cam and the two cams may, for example, be geared to one another.

The coupling between the motor cam and the blocking cam may be configured to permit a degree of relative rotation between the two cams. For example, in its rotation between the closed state and the open state, the motor cam has a first free rotation phase that is followed by a subsequent coupled rotation of the two cams. Similarly, after switching the bolt into the bolt open position, the motor and the motor cam rotate in a closing rotation to the closing state, causing the blocking cam and the motor cam to rotate partially together—the motor cam rotated by the motor while the blocking cam being biased to rotate by the biasing element through the intermediary of the floating block, until the further rotation of the blocking cam is blocked by the bolt; then the permitted relative rotation of the cams allows the motor cam to continue its rotation to its closed state, while the blocking cam remains in a lock-ready state (as defined hereinbelow), in which the blocking cam can rotate into said first rotational state upon switching the bolt to the bolt locking position, the rotation being induced by the bias of said biasing element.

By an embodiment, one of the motor cam and the blocking cam has a recess on a coupling face facing the other one of the one of the motor cam and the blocking cam, the recess being defined between a first recess boundary and a second recess boundary, while such other one of the motor cam and the blocking cam has a projection fitting into said recess permitting relative rotation of the two cams between a first relative rotational position in which the first recess boundary rests against said projection and a second relative rotational position in which the second recess boundary rests against said projection. Said recess is typically, albeit not exclusively, defined in the coupling face of the motor cam and said projection in the blocking cam.

By an embodiment, the lock has (i) a first, locked operational state, in which the motor cam is in the first rotational state, with said first recess boundary resting against said projection, thereby blocking rotation of the blocking cam; (ii) a second, intermediate operational state, in which the motor cam is rotated such that the second recess boundary comes to rest against said projection, whereby further rotation of the motor cam towards the second position yields concurrent rotation of the blocking cam against the bias of the biasing element; (iii) a third, open operational state in which the motor cam is in said second rotational state and said blocking cam is in the non-blocking state, permitting to switch of the bolt from the bolt locking position into the bolt open position; and (iv) a fourth, locking-ready operational state in which the blocking cam is in said locking-ready intermediate state, whereby upon switching the bolt into the bolt locking position, the blocking cam can rotate into said first rotational state, the rotation being induced by the bias of said biasing element.

By one embodiment of this disclosure the displacement of the bolt between the bolt open position and bolt locking positions is along a linear path, which may, by some embodiments, be by a manual operation mechanism, or may be propelled by an electric motor operable to displace the bolt along said linear path.

By one embodiment the bolt motor is rotatable about a bolt motor axis extending parallel to said linear path to rotate a threaded shaft. The threaded shaft is coupled to a coupling element such that rotation of the shaft causes a linear displacement of the coupling element in a direction that is parallel to said linear path of the bolt. In a first rotational direction of the motor and, hence, of the threaded shaft, the coupling element is displaced in a direction parallel to said linear path from an extended state to a retraced state, and in a second rotational direction, opposite the first, the coupling element is oppositely displaced from the retracted state to the extended state. The is coupled to said coupling element such that displacement of the coupling element from the extended to the retraced state causes a corresponding displacement of the bolt between the locking position and the open position.

By one embodiment, the rotation of the bolt motor in said second rotational direction and, hence, the displacement of the coupling element from the retracted state to the extended state, displaces the bolt from the bolt open position to the bolt locking position.

By one embodiment, the displacement of the bolt motor is activated to rotate in said second direction when the bolt is aligned with a locking recess, namely when the bolt is opposite said recess that can, thus, receive to bolt's front end portion when it is displaced into its locking position. This may be achieved, by some embodiments, through a properly configured position sensor.

By one embodiment, the bolt is fitted with a bolt pin extending normal to the bolt path, the bolt pin being received in and held within an opening defined in said coupling element.

By one embodiment, the displacement of the bolt from the locking to the open position is against a biasing force of a biasing member. The coupling between the bolt and the coupling element is such permitting displacement of the coupling element from the retracted to the extended state without displacing the bolt into the bolt locking position, with the bolt remaining biased into the bolt locking position by the said biasing member.

By one embodiment after a time period following displacement of the bolt into the bolt open position the bolt motor operates to displace the coupling element into the extended state to permit the bolt to automatically displace into the bolt locking position by the biasing force of said biasing member.

By one embodiment, the lock housing comprises a through-bore in a portion thereof intended for fitting opposite a corresponding opening in a safe door on which the safe lock is installed.

The lock typically comprises a control module and a battery (or a power unit), that may be housed within the housing or may be external to the housing and linked by appropriate power cables and communication links. The control module may be activated by an external module, for example from mobile communication device carried by a user and configured to emit a wireless encrypted command signal that activates the control module. Upon such activation, an opening sequence, as described herein, is initiated, permitting opening of the lock. As already noted above, the opening of the lock, permitted by the rotation of the blocking cam to the non-blocking state, may be performed, by some embodiments, through an electric activation of the lock or, by other embodiments, through manual manipulation, e.g. rotation of a handle.

The safe lock may comprise one or more internal microswitches that provide an indication of the overall lock status. In particular, the lock may comprise a blocking cam-associated microswitch configured to provide an indication that the blocking cam is in the closed state and, hence, a lock locking indication.

Another aspect of this disclosure provides a safe lock that comprises a housing, that houses a bolt and a bolt blocking mechanism; the bolt is switchable, in a locking plane, between a bolt open position and a bolt locking position; the bolt blocking mechanism is configured to switch between a bolt-blocking state and a bolt non-blocking state by an unblocking command from a control module; the housing comprises a through-bore in a portion thereof intended for fitting opposite a corresponding opening in a safe door on which the safe lock is installed.

Standard safe doors have through-bores in a portion under which the lock is attached. This through-bore is a weak spot for tempering with the lock by either drilling, impact on the lock's housing, or through the use of explosives. The through-bore in the lock's housing prevents such tempering. The through-bore in the safe door's has typically, a diameter of 12 mm. Through-bore in the safe lock of this disclosure has, typically, a diameter above 12 mm, e.g. about 12, 13, 14, 15, 16, 17, 18, 19, 20, 21, 22 mm or even more.

As used herein, the singular form a, an and the include plural references unless the context clearly dictates otherwise.

As used herein, the term about is meant to encompass deviation of ±10% from the specifically mentioned value of a parameter.

Throughout this disclosure, unless the context requires otherwise, the word comprise, and variations such as comprises and comprising, will be understood to imply the inclusion of a stated integer or step or group of integers or steps but not the exclusion of any integer or step or group of integers and steps.

Generally it is noted that the term at least one as applied to any component of a composition of the invention should be read to encompass one, two, three, four, five, six, or more occurrences of said component in the safe lock this disclosure.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

### BRIEF DESCRIPTION OF THE DRAWINGS

In order to better understand the subject matter that is disclosed herein and to exemplify how it may be carried out in practice, embodiments will now be described, by way of non-limiting example only, schematically shown in the accompanying drawings, in which:

FIG. 1 shows a safe lock in accordance with an exemplary embodiment of this disclosure, electrically coupled to a power module.

FIGS. 2A-2F are cross-sectional views of the safe lock through a plane parallel to the upper face of the lock of FIG. 1, showing the safe lock in several operational states, including a locked state (FIG. 2A), an intermediate unlocked state (FIG. 2B), an open state (FIG. 2C), a locking-ready state (FIG. 2D), a re-locked state (FIG. 2E), and a secured state (FIG. 2F) being identical to the locked state.

FIGS. 3A-3F are cross-sectional views of the safe lock along line III-III in FIG. 2A, in corresponding states to those of FIGS. 2A-2F.

FIG. 4A-4B is an isometric view of a safe lock according to another exemplary embodiment of this disclosure fitted onto a safe door.

FIG. 5 is an isometric view of the lock of FIGS. 4A-4B from the inner side of the safe door, with the stem retaining element being removed.

FIG. 6 is a cross-section through in a plane parallel to that of the lock's upper face of FIG. 5.

FIG. 7 is a cross-section through lines VII-VII in FIG. 6, with the lock attached to a safe door.

FIG. 8 is a cross-section through lines VIII-VIII in FIG. 6, with the lock attached to a safe door.

FIG. 9A shows a side view of a safe lock of another exemplary embodiment that comprises a bolt motor operable to displace the bolt along a linear path, fitted onto a safe door panel (a portion of the panel is shown).

FIG. 9B is a perspective view of the safe lock of FIG. 9A and a portion of the safe's locking arm with a bolt recess configured to receive the front portion of the lock's bolt.

FIGS. 10A-10C show opening and locking sequence of a safe lock according to an embodiment of a lock of the kind shown in FIGS. 9A-9B, with the cover removed for ease of viewing of operation of the bolt motor.

FIGS. 11A-11D show opening and locking sequence of a safe lock according to another embodiment of a lock of the kind shown in FIGS. 9A-9B, with the cover removed for ease of viewing of operation of the bolt motor.

### DETAILED DESCRIPTION OF EMBODIMENTS

In the following description specific embodiments will be described, with reference to the annexed drawings. These specific embodiments are illustrative of the general discourse discussed above and should not be construed in any way as limiting this disclosure.

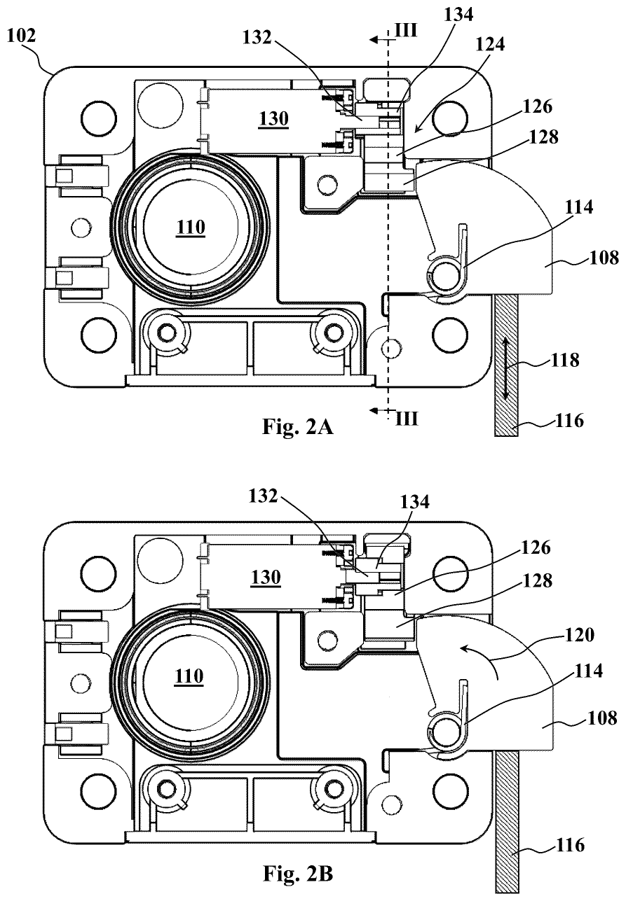

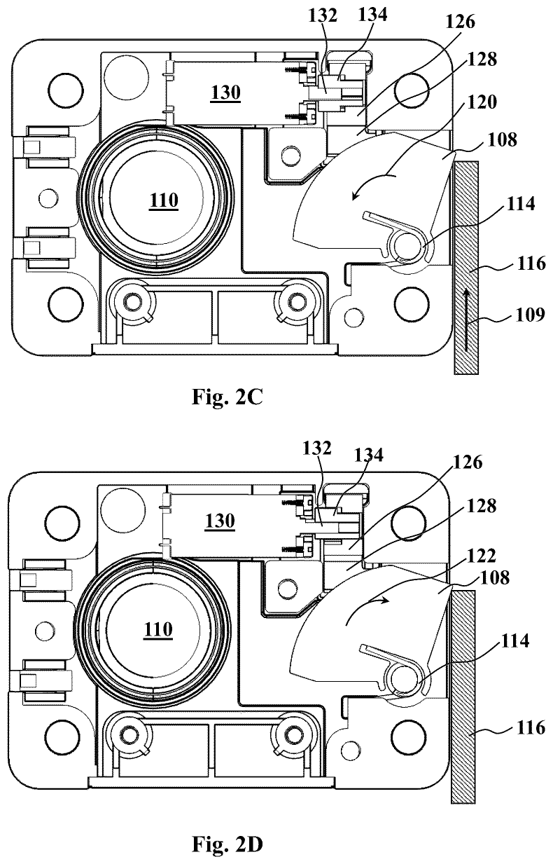

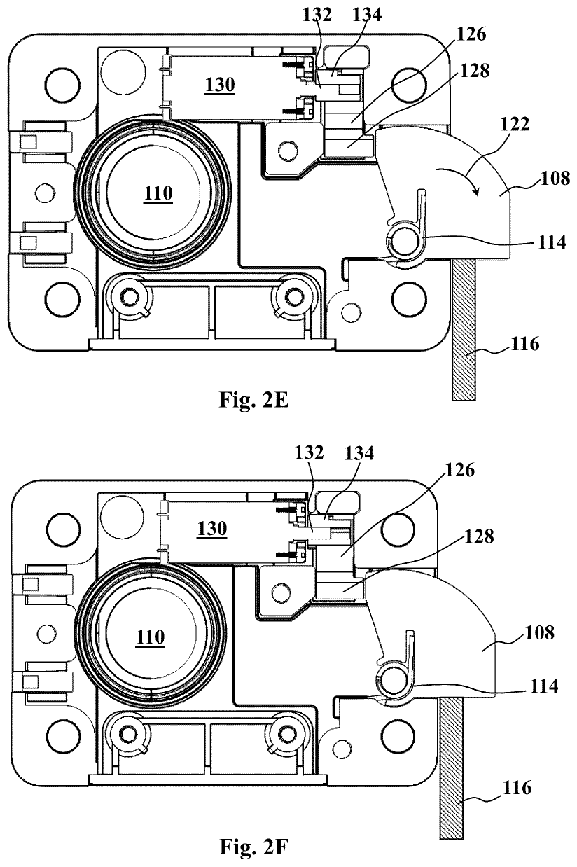

In the following description directions will be made in connection in the manner that they are seen in the specific picture. For example, the term “vertical” is used in reference to bi-directional arrow 118 in FIG. 2A or the terms “upwards” and “downwards” are used in reference to arrows 120 and 122, respectively. It should be understood that the use of this directionality of for convenience only and may not necessarily be reflective of the directions in actual use which may be different.

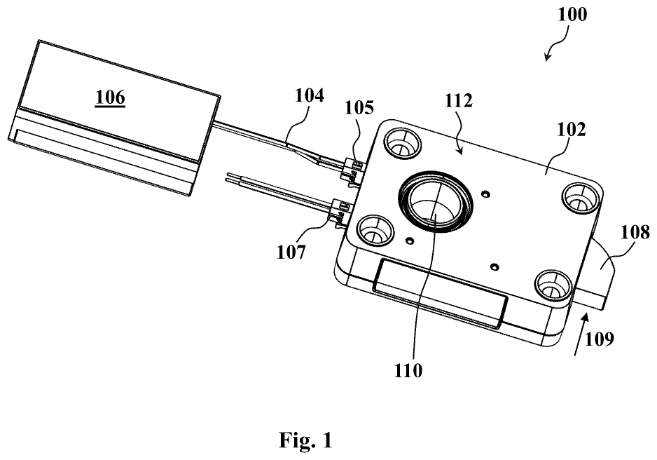

Reference is first made to FIG. 1, showing a safe lock 100 according to an embodiment of this disclosure. The safe lock 100 has a housing 102 and is coupled through a power line 104 extending from a socket 105, to a power module 106. There is another socket 107 in the housing intended for data transmission. It should be noted that in other embodiments, the power module, e.g. a battery, may be housed within the housing. Comprised within the housing is a control module (not shown) that is wirelessly activated, for example, by a mobile communication device with a dedicated application configured to transfer an encrypted activation signal to the control module.

As can also be seen in FIG. 1, the lock comprises a rotary bolt 108, seen in this figure in a bolt locking position. Bolt 108 may be actuated to switch in a rotary bolt path, represented in FIGS. 2B and 2C by an arcuated arrow 120, from the bolt locking position (FIGS. 2A-2B) to a bolt open position (FIGS. 2C-2D), through a bolt manipulating rod 116 (as will be explained below) that is part of a safe door and that pushes the bolt in a direction of arrow 109.

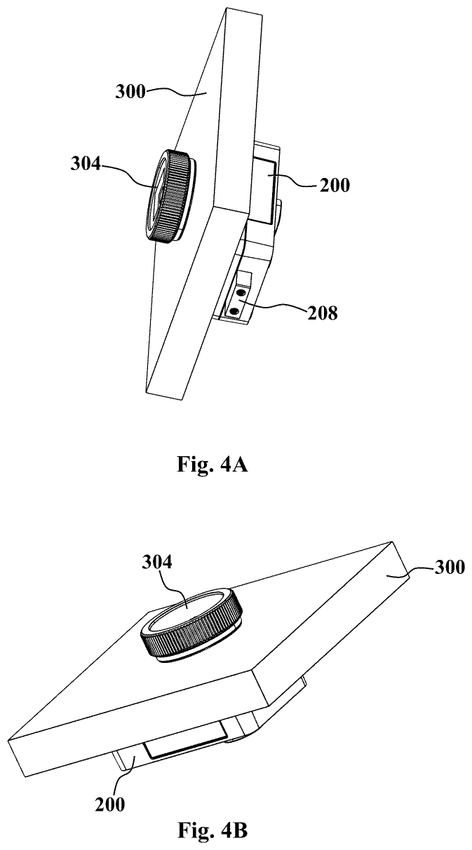

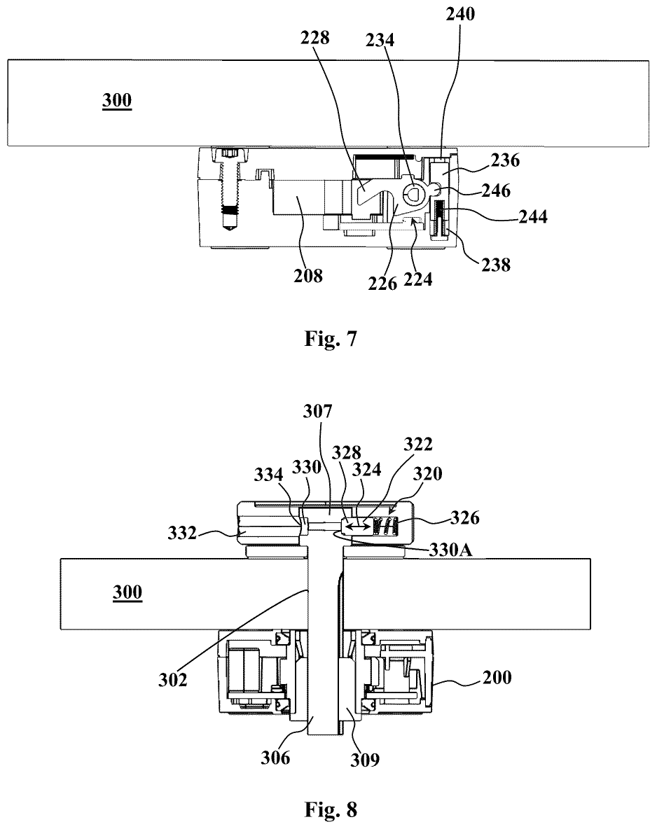

Lock 100 includes a through-bore 110 that, once installed into a safe door, is opposite a standard through-bore that standardly exists in safe doors and intended to be used for the passage of various control cables linking an external control box to the safe; or in other types of safe locks, such as that of the embodiment shown in FIGS. 4A-8, the same opening serves also for passage of a stem coupling an external handle or knob to the bolt operating mechanism within the lock. The safe door's through-bore typically has a standard diameter of 12 mm whereas the through-bore 110 of the lock has typically a larger diameter, of about 16-20 mm, e.g. about 18 mm.

The position of through-bore 110 renders the safe lock of the embodiments of this disclosure, e.g. exemplary embodiments shown herein, more tampering-resistant as compared to other safe locks in which certain elements of the lock occupy the space at the location of the through-bore of these embodiments. To further explain, one of the ways for tempering a safe is drilling through the through-bore in the safe door, which is more prone to such tampering as compared to other portions of the safe. In a standard safe lock that does not have a through-bore of the kind described herein, such drilling would eventually meet one or more elements of the lock with possible outcome of damaging the mechanism and the locking of the safe, hence permitting unauthorized opening of safe. In the exemplary embodiments shown herein, such drilling, while damaging a knob or cables as the case may be, will not mechanically damage the lock's mechanism within the housing. This is particularly so in a lock of some embodiments disclosed herein, in which a blocking cam (to be described below) is mechanically biased by a floating block (also to be described below) into a blocking state, which has a mechanical rest state that blocks the bolt from switching to the block opening position and will remain in such a rest state as long as the electric motor 130 is not activated to force the rotation of the blocking cam into its non-blocking state. Thus, damaging any electric cable or a stem passing through the safe door's through-bore will not weaken the locking of the safe. To further illustrate the significantly improved tampering-resistance of the lock, one of the ways to break into a safe is by impacting the lock with a mechanical element inserted through the safe door's bore or by the use of explosives. A lock of this disclosure is impact-resistant, as any impact, whether mechanical or by the use of explosives, will meet an opposite void constituted by the lock's through-bore.

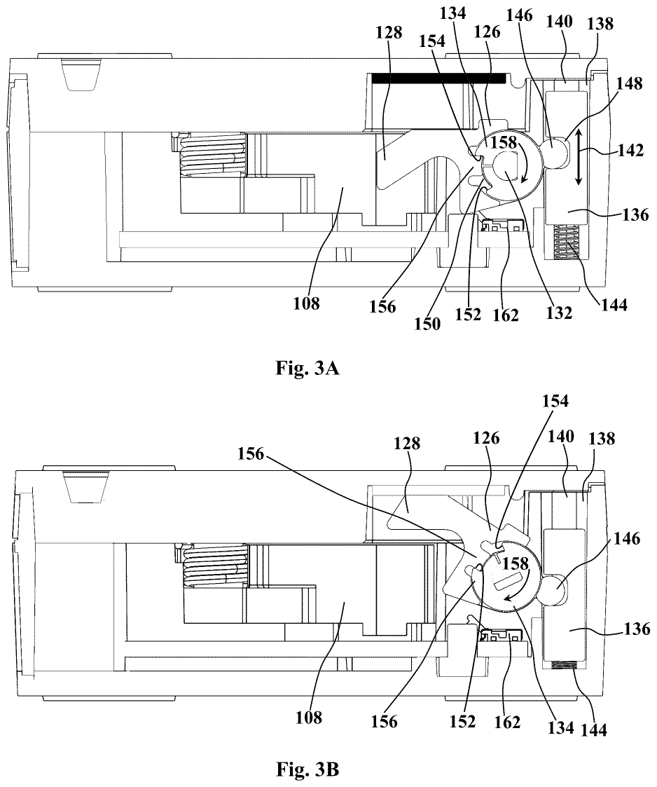

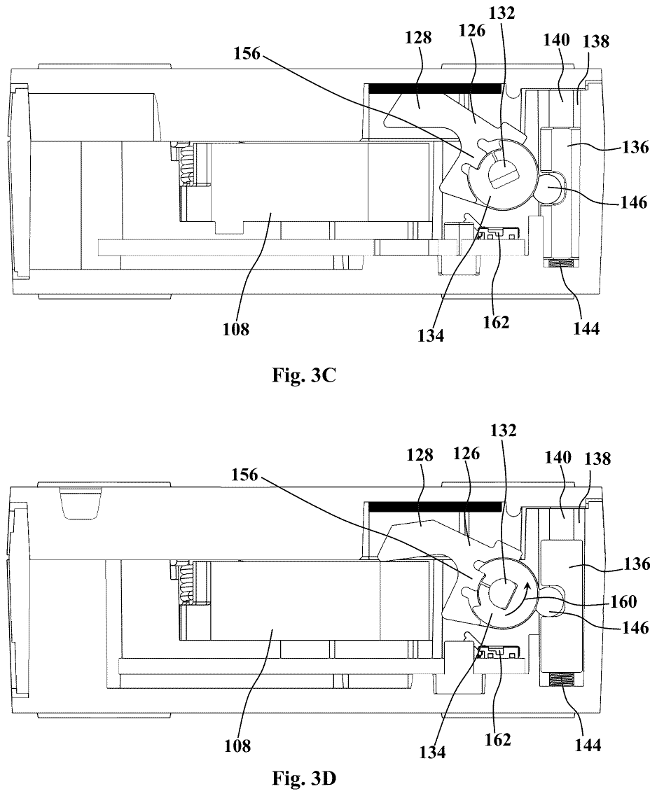

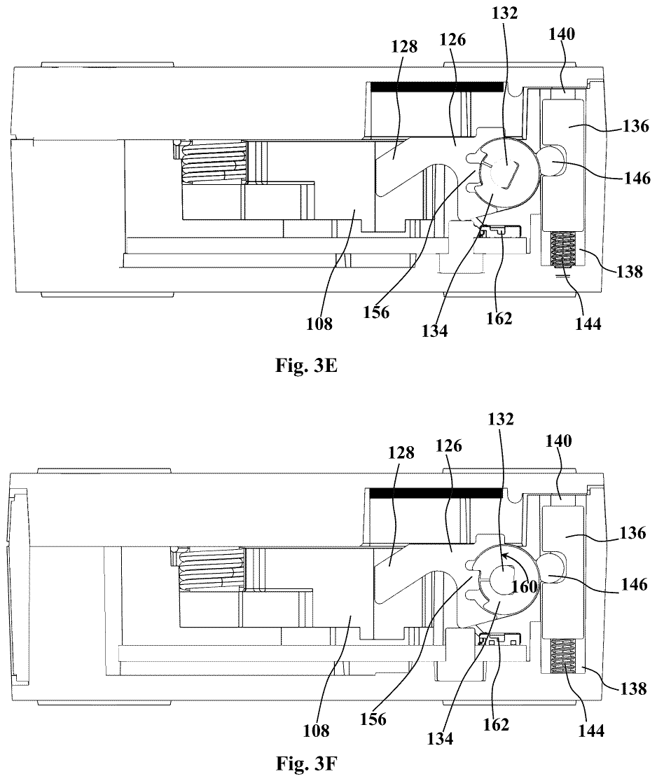

Reference is now being made to FIGS. 2A-3F illustrating several operational states of the lock of FIG. 1, where FIGS. 2A-2F are cross-sectional views parallel to the upper face 112 and where FIG. 3A shows a cross-sectional view along line III-III in FIG. 2A, and FIGS. 3B-3F in corresponding states to those of FIGS. 2B-2F.

As can be seen in FIGS. 2A-3F, housed within housing 102 is a bolt 108 that has an associated torsion spring 114 that acts to bias the bolt 108 into the bolt locking position as seen in FIGS. 2A-2B and FIGS. 2E-2F. When the bolt switches to the bolt open position, seen in FIGS. 2C-2D, this is against the bias of torsion spring 114. The switching of the bolt into the bolt open position is through a manipulation rod 116 (partially shown in FIGS. 2A-2F), which reciprocates in a liner direction represented by vertical bi-directional arrow 118 in FIG. 2A. When shifted upwards, through manipulation of a handle or knob (not shown) in the safe door, in the direction of arcuated arrow 120 in FIGS. 2B-2C, such upward shifting of rod 116 causes the rational shift of the bolt 108 in a rotational bolt path into the bolt unlocking position, against the bias of torsion spring 114. Once the rod 116 is shifted back downwards, in the direction of arcuated arrow 122 in FIG. 2D-2E, the bias of torsion spring 114 causes the return of the bolt 108 back to the bolt locking position. The switch of the bolt to the bolt open position is blocked, in a rest state of the lock, by a bolt blocking mechanism, generally designated 124, that is also housed within housing 102. The bolt blocking mechanism will now be described.

The blocking mechanism 124 comprises a blocking cam 126, seen in side-view in in FIGS. 3A-3F and a cross-sectional view in FIGS. 2A-2F. The blocking cam 126 has an extending portion in the form of an arm 128 that in the state shown in FIGS. 3A, 3E and 3F blocks the rotational displacement of the bolt 108 from the bolt locking position (seen in FIGS. 2A-2B) to the bolt open position (seen in FIGS. 2C-2D). The blocking mechanism 124 also comprises a servo electric motor 130, which may be a gear electric motor with a gear ration of about 1:200. Extending from the motor is a motor axel 132 and a motor cam 134 fixed to the motor axel 132 and rotatable thereby. The blocking mechanism 124 further comprises a floating block 136 accommodated within a space 138 and fitted over guiding rod 140, space 138 and rod 140 jointly define a linear vertical reciprocation track, guiding reciprocation of the floating block 136 in the direction represented by the bi-directional arrow 142 (shown in FIG. 3A). Floating block 136 is upwardly biased by biasing element, which, in this embodiment, is a helical spring 144 fitted around the guiding rod 140. The floating block 136 can be reciprocally displaced between its first position, seen in FIG. 3A and its second position, seen in FIG. 3B, such reciprocation being against the bias of spring 144 in the downwards direction and biased by the spring 144 in the upwards displacement.

As can be seen, blocking cam 126 that envelopes the motor cam 134, as can best be seen in FIGS. 2A-2F, has a rounded projection 146 that fits into a receiving recess 148 in the floating block 136. Consequently, the rotation of the blocking cam 126 causes a concomitant displacement of the floating block 136 to its second position (FIG. 3B) against the bias of biasing element 144.

The motor cam 134 has a recess 150 on a coupling face thereof, the recess extends between a first recess boundary 152 and a second recess boundary 154. The blocking cam 126 has a coupling projection 156 that fits into recess 150 and permitting relative rotation of the two cams between a first relative rotational position (seen, for example, in FIG. 3A) in which the first recess boundary 152 rests against the coupling projection 156, and a second relative rotational position (seen, for example, in FIG. 3B) in which the second recess boundary 154 rests against the coupling projection 156. This arrangement permits some degree of freedom in the rotation of the motor cam 134 between the two relative rotational positions, and then a coupled rotation where one of the recess boundaries causes coupled rotation of the cams. The coupled rotation when the motor cam 134 rotates in the opening rotation, which in the view of FIGS. 3A-3B is clockwise and represented by arcuated arrow 158, yielding a concomitant displacement of the floating block 136, against the bias of spring 144, into the floating block's second position. Consequently, when rotated in a closing rotation, represented by a counterclockwise arcuated arrow 160 in FIG. 3D, the bias of the spring 144, through the intermediation of the floating blook 136, induces a biased rotation of the blocking cam 126 in the same direction.

In this embodiment, the motor cam 134 and the blocking cam 126 are both co-planar, although, as already noted above, the co-planarity is an example, and other arrangements are also possible. The blocking mechanism may include microswitches and other sensors having the purpose of indicating the lock status. One such sensors, is microswitch 162 that is engaged when the blocking cam is in the locked position of FIGS. 3A and 3F, providing an indication that the lock is locked.

FIGS. 2A-2F and corresponding FIGS. 3A-3F show several operational states, that will now be described.

In the locked state, shown in FIGS. 2A and 3A, arm 128 of blocking cam 126 prevents any displacement of bolt 108. As long as blocking cam 126 remains in this position, the safe is locked. Activating the motor 130 results first in a free opening rotation of the motor cam 134 and until second recess boundary 154 contacts coupling projection 156, whereupon the motor cam 134 and the blocking cam 126 rotate together into the intermediate state (seen in FIGS. 2B, 3B), concomitantly with the displacement of the floating block 136 into the second position, against the bias of spring 144. At this intermediate state, arm 128 is removed from the bolt path, thereby permitting switching of bolt 108 into the bolt open position (FIGS. 2C, 3C), in a manner described above.

The motor 130 is then activated into an opposite, closing rotation, represented by arcuated arrow 160, whereupon the bias of spring 144 (through the intermediation of floating block 136) induces rotation of the blocking cam 126 until arm 128 rests on top of bolt 108, and through the relative rotation permitted between the two cams, enables continued motor-induced rotation of the motor cam 134 to the state seen in FIG. 3D, in which recess boundary 152 rests against projection 156. This is a state referred to herein as a “locking-ready state” (FIGS. 2D and 3D). In the locking-ready state, when the bolt 108 is switched into the bolt locked position, the blocking cam 126 is biased by spring 144 (through the intermediation of floating block 136) to rotate into its locked state.

When the bolt is switched into its locking state, the bias exerted by spring 144 causes the locking bolt to switch into its relocked state, blocking again the switch of the bolt 108 into the bolt open state, as seen in FIG. 3E. Subsequently, the electric motor 130, with motor cam 134, completes the closing rotation into the secure state, seen in FIG. 3F, which is identical to the initial state, that of FIG. 3A.

FIGS. 4A-8 illustrate another exemplary embodiment of this disclosure. In this embodiment the same reference numeral to those of FIGS. 1-3F, shifted by 100 to indicated elements that have a different function. For example, the electric motor 230 in the embodiment of FIGS. 4A-7, has the same function as electric motor 130 of the embodiment of FIGS. 1-3F. The reader may refer to the above description for an understanding of these elements and their function. The focus in the description below will be made on the elements that differ from the embodiment of FIGS. 1-3F.

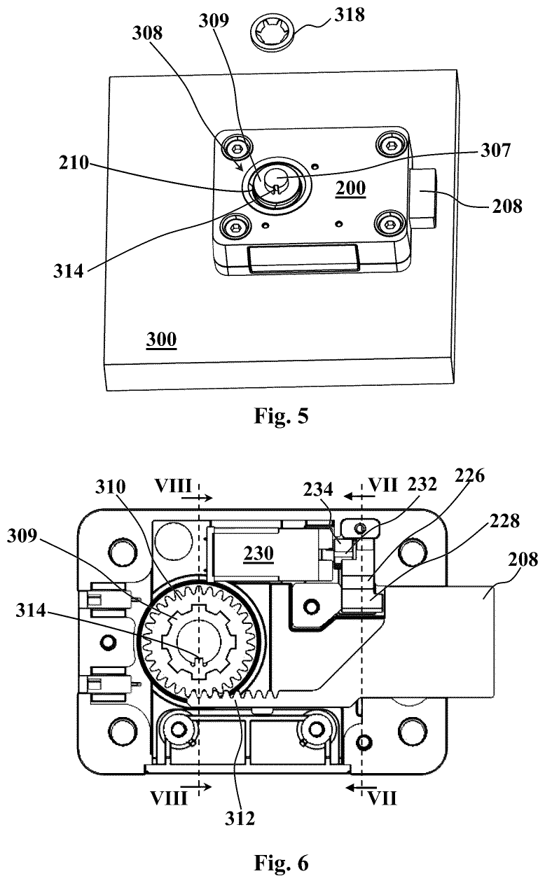

Lock 200, seen here fixed to a safe door 300, of which a portion is schematically represented. The bolt 208 of this embodiment is a sliding bolt, as will be described below. Defined in the lock 200 is a bore 210 (best seen in FIG. 5) which is opposite a through-bore 302 in door 300 (seen in cross-section in FIG. 8). Provided in this embodiment is a knob 304 that operates the bolt as will be explained below.

Extending from knob 304 and through-bore 302 is a stem 306 with an external stem head 307. The stem extends into bore 210 in the lock housing and is coupled to a bolt displacement mechanism, generally designated 308. This mechanism includes a busing 309 that is rotationally coupled through a tooth-and-groove coupling to cogwheel 310 that is geared to a toothed rack 312 extending from bolt 208. Bushing 309 has an internally pointing tooth 314, that fits in groove 316 of stem 306. Such fitting couples stem 306 with the bushing 309, whereby, through rotation of the knob 304, the bolt 208 can be slidingly switched from the bolt locking position, seen in FIGS. 4A-8 to the bolt open position (not shown) and vice versa. The end of stem 306 is fitted with a stem retaining element 318 (seen separated from the lock in FIG. 5), and after such fitting the stem with the knob are firmly fixed in position as seen in FIGS. 4A-4B.

In case of a tampering attempt through the through-bore 302, a potential strategy would be to impact the lock through the door's through-bore 302. In a lock shown in FIGS. 4A-8 such impact would merely push the stem 306 through the bore into the safe, and possibly also the bushing 309, without any damage to the lock mechanism.

The operation of the bolt blocking mechanism 224 and its various elements is similar to that of the exemplary embodiment of FIGS. 1-3F.

The knob 304 is coupled to the stem head 307 through a clutch mechanism 320 that includes a plunger 322 that can reciprocate in a radial path, represented by bi-directional arrow 324 and is centrally biased by a spring 326. Formed in the stem head 307 is an annular recess 330 with a deeper part 330A that is engaged by engaging portion 328 of plunger 322. The opposite side of annular recess 330 is engaged by engaging portion 334 of bushing 332.

When the blocking mechanism unblocks the displacement of bolt 208, by rotating the blocking cam into the non-blocking state, rotation of the knob, that is coupled to stem head 307 through plunger 320 that engages the deeper part of the recess 330A will cause displacement of the bolt 208. However, when the blocking mechanism 224 is in a locked state, forcefully turning knob 304 will not damage the gear wheel 310, the toothed extension 312 or the coupling between the two, but rather will cause a radial displacement of the plunger against the bias of spring 326 and will then freely slide within the narrower portions of the annular recess 330 and, hence, the knob will freely rotate about stem head 307.

It should also be noted that a tempering attempt by drilling through bore 302, which is the weakest point of safe door 300, such drilling will not impair the blocking mechanism 224 and the safe lock will remain locked.

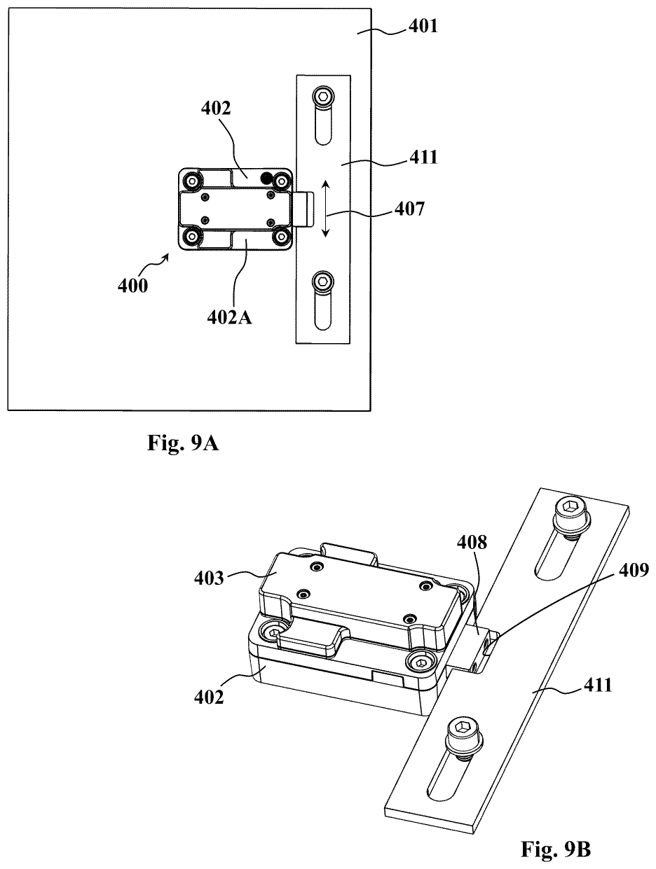

Reference is now made to FIGS. 9A-9B, showing a safe lock 400 that comprises an electric bolt motor that is configured and operable for linear displacement of the bolt. In distinction from the lock of FIGS. 5 and 6, an auxiliary housing 403 is fitted onto a top panel 402A of the main housing 402 that house the bolt motor to be described below. As can also be seen, front end portion of bolt 408 is received in a bolt recess 409 which is formed in safe locking arm 411 that is fixed to the safe's door 401 (only a portion of the safe door 401 and the locking arm are seen in FIGS. 9A-9B). The locking arm 411 is reciprocal in a direction represented by two-headed arrow 407 permitting locking and opening of the safe's door. When the bolt 408 is received in bolt recess 409 locking arm 411 is blocked from displacement and remains in its locking state, seen in FIGS. 9A-9B.

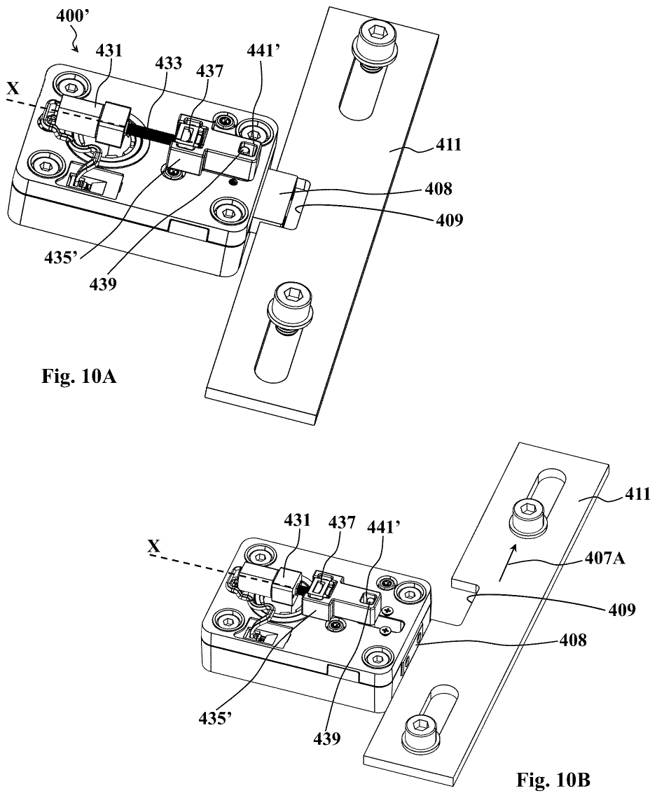

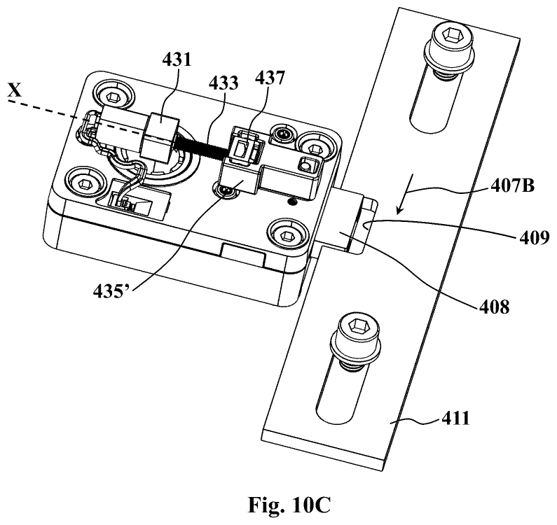

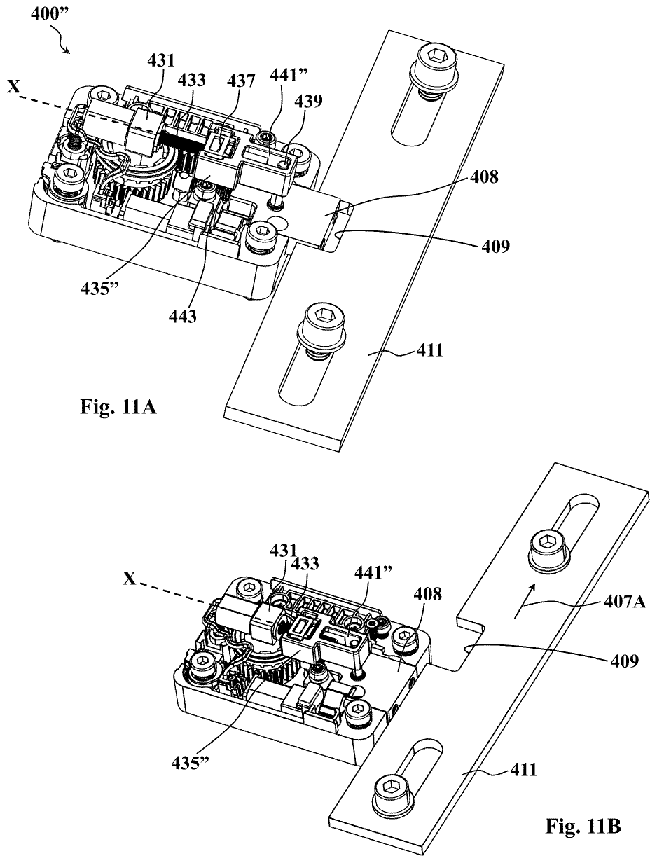

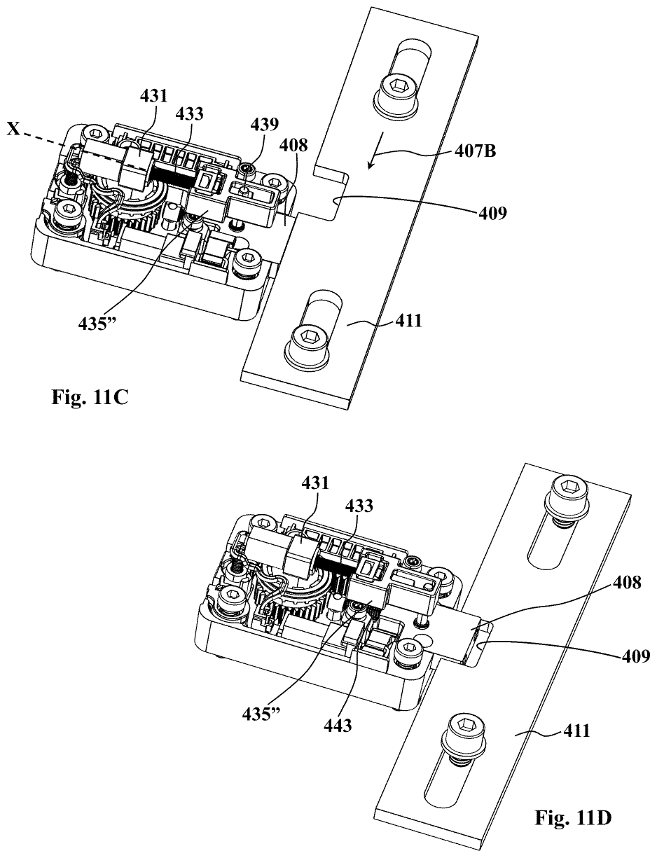

FIGS. 10A-10C and 11A-11D show two exemplary embodiments of a lock, 400′ and 400″ respectively. In both of locks 400′ and 400″, a linear displacement of bolt 408 is propelled by an electric motor, as will now be described. Locks 400′ and 400″ have the same bolt blocking mechanism as described above with reference to the embodiments of FIGS. 1-8, however with the bolt being displaced in a linear path by an electric motor (in distinction from the manual operation of the bolt as in the previous embodiments).

Turning first to FIGS. 10A-10C, seen is a safe lock 400′ that has bolt motor 431, being an electric motor and has a bolt motor axis X, that extends in a direction parallel to the linear path of displacement of the bolt 408. Motor 431 rotates a threaded shaft 433, that is coupled to a coupling element 435′. The threaded shaft 433 is received in a complementary threaded bore (not seen) of a nut element 437 of the coupling element 435′, such that rotation of shaft 433 results in a linear displacement of the coupling element 435′ in a direction parallel to said linear path, between an extended state (shown in FIGS. 10A and 10C) and a retracted state (shown in FIG. 10B), which respectively correspond to the bolt locking position and the bolt open position.

The bolt 408 is fitted with a bolt pin 439, that extends from the bolt in a direction normal to the linear path (similarly to pin 439 of the embodiments of FIGS. 11A-11D) and is received in an opening 441′ defined in the coupling element 435′.

The sequence of operation of lock 400′ is seen in succession in FIGS. 10A-10C. In a first step of an opening sequence, the bolt motor 431 is operated to rotate in a first rotational direction, to thereby displace the coupling element 435′ from the extended state (FIG. 10A) to the retracted state (FIG. 10B), thereby causing displacement of the bolt 408 from the bolt locking position into the bolt open position, respectively, and out of recess 409. When the bolt 408 is in its open position, locking arm 411 can be shifted in the direction of arrow 407A (by a safe opening mechanism, not seen and known per se) to open the safe door 401.

In a subsequent, locking sequence, the locking arm 411 is displaced in the direction of arrow 407B. Once the recess 409 is aligned with bolt 408, bolt motor 431 is operated to rotate in a second rotational direction, opposite the first rotational direction. This displaces the coupling element 435′ and correspondingly displaces the bolt 408 into the bolt locking position, with its front end received in recess 409, as seen in FIG. 10C, thereby locking the safe.

In the embodiment seen in FIGS. 10A-10C, the cross-sectional dimension of opening 441′ is larger than the cross-sectional dimension pin 439 permitting some degree of freedom for the initial operation of motor 431, permitting some initial load-free rotation of motor 431 in both opening and locking sequences.

Turning now to FIGS. 11A-11D showing another embodiment of a lock 400″, where the displacement of bolt 408 from the locking position to the open position is against the bias of a biasing member, i.e. a helical spring 443, and the opposite displacement (namely from the open position to the locking position) is through the action of this biasing member. In these figures, like elements to those of FIGS. 10A-10C will be given like reference numerals. In these figures the upper cover element of housing 402 has been removed to show internal elements with particular attention being made there to helical spring 443. It is also to be noted that opening 441″ in coupling element 435″ is different than opening 441′ in coupling element 435′ in the embodiment of FIGS. 10A-10C. The significance of both will now be explained.

As can be seen, opening 441″ is elongated, thereby permitting relative displacement of coupling element 435″ without corresponding displacement of bolt 408. The sequence of operation will now be described.

FIG. 11A shows the lock 441″ with the bolt 408 in the locking position with its front portion received in bolt recess 409. Upon initiation of an opening sequence, motor 431 is operated, rotating threaded shaft 433 in a first rotational direction to thereby displace the coupling element 435″ into the retracted state seen in FIG. 11B. This displacement pulls pin 439″, which is fixed to and extends from bolt 408 in a direction normal to the linear path of displacement of the bolt, and which consequently displaces the bolt 408 from its bolt locking position in FIG. 11A to its open position in FIG. 11B in which the bolt's front end is extracted out of bolt recess 409. This displacement of the bolt is against the bias of helical spring 443, which is fitted on a shaft that is received within a bore in the rear of the bolt (not shown) and is compressed is such displacement of the bolt to thereby bias the bolt into the bolt locking position. The safe arm 411 can then be displaced in the direction of arrow 407A to permit opening of the safe door.

At the next stage, seen in FIG. 11C, bolt motor 431 is rotated in a second rotational direction to advance the coupling element 435″ from the retracted state shown in FIG. 11B to the extended state shown in FIG. 11C. At this position, the bolt 408 is blocked from advancement and is pressed by the helical spring 443 against a side face of the safe arm 411. In this position, the bolt is in a “locking ready” position, and once arm 411 is moved in a direction of arrow 407B and the recess 409 becomes aligned with the bolt 408, the helical spring 443 causes the bolt 408 to advance into the locking position, in which its front end portion is received in recess 409 to thereby lock the safe.

1. A safe lock, comprising:
a housing, housing a bolt switchable, in a bolt path extending in a locking plane, between a bolt open position and a bolt locking position, and a bolt blocking mechanism;
the bolt blocking mechanism comprises
a blocking cam that is rotatable in a cam plane normal to said locking plane, between a blocking state, in which the blocking cam blocks the bolt from switching into the bolt open position, and a non-blocking state in which such switching is permitted,
a floating block that is reciprocally displaceable between a first block position and a second block position, and being biased, by a biasing element, into a first block position, and comprises
an electric motor that is rotatable in an opening rotation between a closed state and an open state and rotatable in a closing rotation between the open state and the closed state;
the blocking cam, the floating block and the electric motor being coupled to one another such that the opening rotation of the electric motor causes rotation of the blocking cam between the blocking state to the unblocking state and a displacement of the floating block from the first block position into the second block position, and such that the bias of the biasing element on the floating block biases rotation of the blocking cam back into said blocking state.

2. The safe lock of claim 1, wherein the blocking cam has an extending portion that, in the blocking state, is situated within the bolt path to thereby block the switch of the bolt into the bolt open position.

3. The safe lock of claim 1, wherein the blocking cam is physically coupled to the floating block.

4. The safe lock of claim 3, wherein
the floating block has a depression,
the blocking cam has a projection that fits into the depression the coupling being through such fitting, and
the coupling permitting concomitant rotation of the blocking cam and linear reciprocation of the blocking cam.

5. The safe lock of claim 1, wherein the floating block is reciprocally displaceable between a first block position and a second block position in a linear track.

6. The safe lock of claim 1, wherein rotational force exerted by the motor exceeds that of the biasing force of the biasing element.

7. The safe lock of claim 1, wherein the bolt locking mechanism comprises a motor cam fixedly coupled to the axel of the motor, the coupling of the motor axle to the blocking cam being through the motor cam.

8. The safe lock of claim 7, wherein the motor cam and the blocking cam are co-planar.

9. The safe lock of claim 8, wherein the coupling between the motor cam and the blocking cam is configured to permit a degree of relative rotation between the two cams.

10. The safe lock of claim 9, wherein in the rotation between the closed state and the open state, the motor cam has a first free rotation phase and a subsequent coupled rotation of the two cams.

11. The safe lock of claim 9, wherein
one of the motor cam and the blocking cam has a recess having a first recess boundary and a second recess boundary, defined on a coupling face facing the other one of the motor cam and the blocking cam, and
the other one of the motor cam and the blocking cam has a projection fitting into said recess permitting relative rotation of the motor cam and the blocking cam, between a first relative rotational position in which the first recess boundary rests against said projection and a second relative rotational position in which the second recess boundary rests against said projection.

12. The safe lock of claim 11, wherein said recess is defined in the coupling face of the motor cam and said projection in the blocking cam.

13. The safe lock of claim 11, having
a first, locked operational state, in which the motor cam is in the first rotational state, with said first recess boundary resting against said projection, thereby blocking rotation of the blocking cam;
a second, intermediate operational state, in which the motor cam is rotated such that the second recess boundary comes to rest against said projection, whereby further rotation of the motor cam towards the second position yields concurrent rotation of the blocking cam against the bias of the biasing element;
a third, open operational state in which the motor cam is in said second rotational state and said blocking cam is in the non-blocking state, permitting to switch the bolt from the locking position into the bolt open position; and
a fourth, locking-ready operational state in which the blocking cam is in said locking-ready intermediate state, whereby upon switching the bolt into the bolt locking position the blocking cam can rotate into said first rotational state, the rotation being induced by the bias of said biasing element.

14. The safe lock of claim 1, wherein the displacement of the bolt between the bolt open position and bolt locking positions is along a linear path.

15. The safe lock of claim 14, comprising a bolt motor operable to displace the bolt along said linear path.

16. The safe lock of claim 15, wherein
the bolt motor is rotatable about a bolt motor axis extending parallel to said linear path to rotate a threaded shaft;
the threaded shaft being coupled to a coupling element such that rotation of the shaft in a first rotational direction causes linear displacement of the coupling element in a direction parallel to said linear path from an extended state to a retraced state, and rotation of the shaft in a second rotational direction, opposite the first, causes opposite linear displacement of the coupling element from the retracted state to the extended state; and wherein
the bolt being coupled to said coupling element such that displacement of the coupling element from the extended to the retraced state causes a corresponding displacement of the bolt between the locking position and the open position.

17. The safe lock of claim 16, wherein the displacement of the coupling element from the retracted state to the extended displaces the bolt from the bolt open position to the bolt locking position.

18. The safe lock of claim 17, wherein the bolt motor is activated to rotate in said second rotational direction when the bolt is aligned with said recess.

19. The safe lock of claim 15, wherein
the bolt is fitted with a bolt pin extending normal to the bolt path; and wherein
the bolt pin is received in an opening defined in said coupling element.

20. The safe lock of claim 16, wherein
the displacement of the bolt from the locking to the open position is against a biasing force of a biasing member; and wherein
the coupling between the bolt and the coupling element is such permitting displacement of the coupling element from the retracted to the extended state without displacing the bolt into the bolt locking position, with the bolt being biased into the bolt locking position by the said biasing member.

21. The safe lock of claim 20, wherein after a time period following displacement of the bolt into the bolt open position the bolt motor operates to displace the coupling element into the extended state to permit the bolt to automatically displace into the bolt locking position by the biasing force of said biasing member.

22. The safe lock of claim 1, wherein the displacement of the bolt between the bolt open position and the bolt locking position is along a rotary path.

23. The safe lock of claim 1, wherein the housing comprises a through-bore in a portion thereof intended for fitting opposite a corresponding opening in a safe door on which the safe lock is installed.

24. The safe lock of claim 1, wherein the housing comprises a through-bore in a portion thereof intended for fitting opposite a corresponding opening in a safe door on which the safe lock is installed.
